(19) United States
(12) Patent Application Publication
(10) Pub. No.: US 2007/0142940 A1
(43) Pub. Date: Jun. 21, 2007

(54) Processes for monitoring user-selected parameters

(76) Inventors: Alan Lewis Ferguson, Peoria, IL (US); Anthony Dean McNealy, Peoria, IL (US); Aaron Michael Donnelli, Peoria, IL (US); Daniel Craig Wood, East Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/312,436

(22) Filed: Dec. 21, 2005

(51) Int. Cl. G05B 15/00

(52) U.S. Cl. 700/83

(57) ABSTRACT

A method for gathering user-selected parameters in a work machine environment includes receiving a set of parameters associated with a work machine controller and providing the received set of parameters to a user interface. The user interface may be configured to allow a user to select one or more parameters from among the received set of parameters. The method may also include receiving operation data based on the one or more parameters selected by the user, wherein the operation data reflects an aspect associated with an operation of the work machine.

### TECHNICAL FIELD

The present disclosure relates generally to data monitoring systems and, more particularly, to systems and methods for monitoring user-selected data in a work machine environment.

### BACKGROUND

Work machines such as, for example, excavators, track-type tractors, on-highway vehicles, dump trucks, motor graders, and other types of heavy machinery typically include equipment that collects information associated with the operation of the work machine. This equipment may be communicatively coupled to a communication network for distributing the collected information to one or more off-board systems. The communication network may provide a common interface that allows users to access operational, status, and/or productivity data associated with one or more of the work machines.

For work machines that include multiple components, the amount of information collected can be substantial, as each component provides a considerable amount of raw data to the network. In some cases, a user may wish to monitor only certain parameters relevant to a particular component or work machine operation. As a result, the user may be required to sort through vast amounts of information to locate data associated with a certain parameter. Not only is such a practice cumbersome, but it may unnecessarily overload the communication network with information that the user is unconcerned with.

One system for reporting user-specific operation data is described in U.S. Patent Application Publication No. 2004/0186927 (“the '927 publication”) to Ervurek et al. The '927 publication describes a system for reporting status information in a process plant. The system of the '927 publication may receive status information from an entity within the process plant and generate a report indicative of the status of the entity based on a user profile. The system may then display the report to a user in accordance with a user-defined format. The system of the '927 publication may also include a computer-readable medium that stores a plurality of predefined representations each corresponding to a preferred graphical representation of the displayed information for a particular user.

Although the system of the '927 publication may provide a means to customize the manner in which status information is displayed to a user, it may still be inflexible and/or inefficient. For instance, the system of the '927 publication does not allow customization of the data collection process. As a result, systems that rely on data that is not reported in one of the default user-selectable representations may become inefficient and/or inoperable.

In addition, the system of the '927 publication may not allow customization of the data collection process. For example, the system of the '927 publication does not allow the user to limit the number of collected parameters based on a user input. Instead, the system of the '927 publication collects all status information available from the entity before filtering the relevant data and reporting the data to the user. As a result, large amounts of unused data may be transmitted over the network, consuming network bandwidth and unnecessarily burdening the network with irrelevant information. Furthermore, systems that require information that is not provided in one of the prepackaged reports may become inefficient by requiring users to sort through the large amount of collected information to extract the relevant data from the system.

The disclosed processes for monitoring user-selected parameters are directed towards overcoming one or more of the problems set forth above.

### SUMMARY OF THE INVENTION

In accordance with one aspect, the present disclosure is directed toward a method for gathering user-selected parameters in a work machine environment. The method may include receiving a set of parameters associated with a work machine controller and providing the received set of parameters to a user interface. The user interface may be configured to allow a user to select one or more parameters from among the received set of parameters. The method may also include receiving operation data based on the one or more parameters selected by the user, wherein the operation data reflects an aspect associated with an operation of the work machine.

According to another aspect, the present disclosure is directed toward a data collection system for collecting operation data in a work machine environment. The system may include a user interface, configured to communicate information with a user associated with the work machine environment, and a processor communicatively coupled to the user interface. The processor may be configured to receive a set of parameters associated with a work machine controller and provide the received set of parameters to the user interface. The processor may also be configured to receive operation data indicative of one or more parameters selected by the user, wherein the operation data reflects an aspect associated with an operation of the work machine.

In accordance with another aspect, the present disclosure is directed toward a work machine environment that may include a work machine configured to perform a task associated with the work machine environment and a data collection system communicatively coupled to the work machine. The work machine may include a controller operatively coupled to a component of the work machine and configured to collect operation data associated with one or more parameters of the work machine. The data collection system may include a user interface, configured to communicate information with a user associated with the work machine environment, and a processor communicatively coupled to the user interface. The processor may be configured to receive a set of parameters associated with the controller of the work machine and provide the received set of parameters to the user interface. The processor may be also be configured to receive operation data indicative of one or more parameters selected by the user, wherein the operation data reflects an aspect associated with an operation of the work machine.

### BRIEF DESCRIPTION OF THE DRAWINGS

FIG. 1 provides a diagrammatic view of a work machine environment according to an exemplary disclosed embodiment;

FIG. 2 illustrates a data collection system according to an exemplary disclosed embodiment; and

FIG. 3 provides a flow diagram of a method according to an exemplary disclosed embodiment.

### DETAILED DESCRIPTION

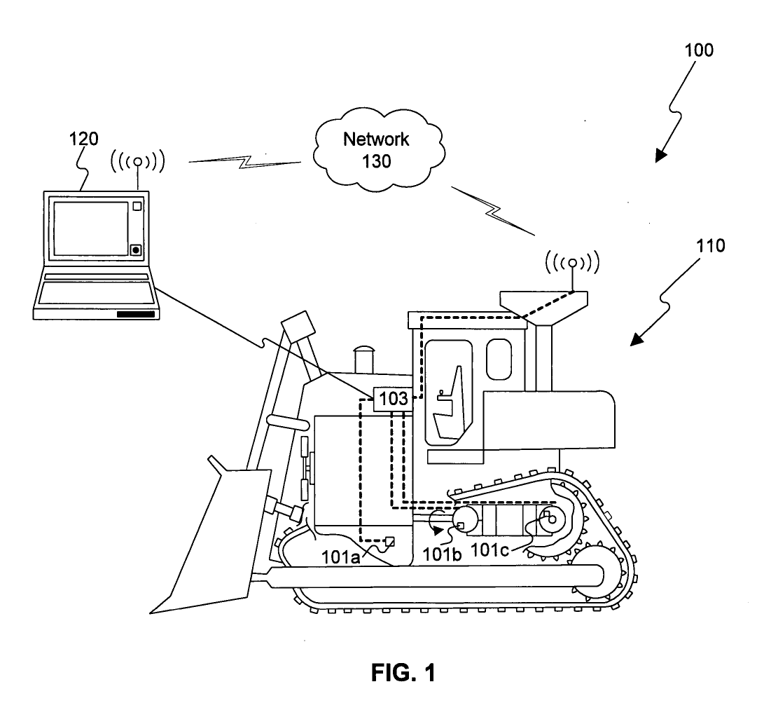

FIG. 1 provides a diagrammatic illustration of an exemplary disclosed work machine environment 100. Work machine environment 100 may include any environment in which one or more work machines 110 operate to perform a task associated with an industry such as mining, construction, farming, manufacturing, transportation, or any other type of industry. For example, work machine environment 110 may include a construction site in which one or more work machines cooperate to perform a task associated with the completion of a construction project.

Work machine environment 100 may include a work machine 110, a data collection system 120, and a communication network 130 to provide communications between work machine 110 and data collection system 120. Although FIG. 1 illustrates work machine environment 100 as containing one work machine, it is contemplated that work machine environment 100 may include multiple work machines. It is also contemplated that work machine environment 100 may include additional and/or different components than those listed above.

Work machine environment 100 may be configured to monitor, collect, and analyze information associated with an operation of work machine 110. Work machine environment 100 may also be configured to distribute the information to one or more off-board systems, such as data collection system 120 or any other computer system associated with work machine environment 100.

Work machine 110 may include any type of equipment configured to perform a task associated with work machine environment 100. For example, work machine 110 may include a mobile or stationary machine such as, for example, an earth-moving machine, an on-highway vehicle, a generator set, an engine system, or any other machine operable to perform a task associated with work machine environment 100. Although FIG. 1 illustrates work machine 110 as a track-type tractor, work machine 110 may include any suitable type of work machine. Moreover, it is also contemplated that work machine 110 may include multiple work machines that individually or cooperatively perform a task associated with work machine environment 100. Work machine 110 may include, among other things, a controller 103 and one or more electronic control modules 101a-c. It is contemplated that work machine 110 may include additional and/or different components than those listed above.

Controller 103 may be communicatively coupled to one or more devices and configured to receive operation data associated with one or more components of work machine 110. For example, controller 103 may be coupled to one or more devices, such as electronic control modules 101a-c, that each may be configured to collect information reflecting an operation of a particular component of work machine 110. Controller 103 may automatically receive the collected information from electronic control modules 101a-c. Alternatively and/or additionally, controller 103 may receive the information in response to a request. For the purposes of the present disclosure, operation data may include information indicative of a status, productivity, health, or other characteristic associated with work machine 110 or one or more of its associated components. For example, operation data may include a physical aspect (e.g., temperature, pressure, speed, etc.), a status indicator, productivity information (load characteristic, efficiency, torque output, etc.), a fault condition, or any other type of data related to the operation of work machine 110.

Controller 103 may include one or more input/output devices (not shown) configured to communicate information to one or more systems associated with work machine 110, such as data collection system 120. For example, controller 103 may include a tranceiver that transmits and receives information over communication network 130. Controller 103 may communicate information in any format suitable for data communication such as, for example, digital, analog, a combination of digital and analog, or any other type of format. Moreover, controller 103 may be configured to communicate data over a variety of communication mediums such as, wireless, wireline, optical, infrared, Bluetooth, or any other suitable medium for data communication.

Electronic control modules 101a-c may include one or more devices configured to monitor and/or control an operation associated with one or more mechanical and/or electrical systems associated with work machine 110. Electronic control modules 101a-c may include, for example, a power system controller that is configured to control and/or regulate the operation of a work machine power source, a cooling system controller configured to monitor and control operation of a cooling system, a transmission controller configured to monitor the operation of the transmission system, or any other electronic control module associated with work machine 110.

Data collection system 120 may be configured to receive information from controller 103 and distribute the information to a user associated with work machine environment 100. For example, data collection system 120 may receive a set of parameters indicative of components and/or data elements that controller 103 is capable of monitoring. Data collection system 120 may provide the received set of parameters to a user associated with work machine environment 100. For the purposes of the present disclosure, the set of parameters may include any information indicating specific data elements that can be measured, monitored, controlled, and/or collected by the controller 103. For example, parameters may include component identifiers (e.g., model numbers, serial numbers, electronic ID numbers, etc.), operational characteristics (e.g., temperature, pressure, fluid level, noise, vibration, voltage, etc.), a list of components associated with controller 103, or any other type of information. Alternatively and/or additionally, the set of parameters may include an identifier (e.g., ID code, etc.) associated with a particular set of data elements which corresponds to one or more particular parameters associated with controller 103. Furthermore, because controller 103 may be coupled to multiple components (e.g., electronic control modules 101a-c, monitoring devices, etc.) it is contemplated that the set of parameters may include information associated with every component of work machine 110 that transmits data (either directly or indirectly) to controller 103. In accordance with one embodiment, the set of parameters may include all operational information that can be monitored by controller 103 in association with work machine 110. Alternatively and/or additionally, the set of parameters may include only a particular subset related to one operational aspect and/or component of work machine 110. It is contemplated that data collection system 120 may be an on-board system that may be, for example, integral to an information system associated with work machine 110. Alternatively and/or additionally, data collection system 120 may include an off-board (e.g., external, standalone, etc.) system in data communication with work machine 110.

Data collection system 120 may also be configured to receive input from a user associated with work machine environment 100 and modify its operations according to the received input. Following the example above, data collection system 120 may receive parameters selected by the user from among the set of parameters provided to the user. Data collection system 120 may collect operation data associated with parameters selected by the user. Thus, data collection system 120 may adapt its data collecting processes based on parameters designated by the user.

Communication network 130 may include any platform that provides a common information link between one or more components operating in work machine environment 100. For example, communication network 130 may communicatively couple one or more work machines 110 to data collection system 120 across a wireless platform such as, for example, a satellite communication system. Alternatively and/or additionally, communication network 130 may include one or more broadband communication platforms appropriate for communicatively coupling one or more work machines 110 to data collection system 120 such as, for example, cellular, Bluetooth, microwave, point-to-point wireless, point-to-multipoint wireless, multipoint-to-multipoint wireless, or any other suitable communication platform. Although FIG. 1 illustrates communication network 130 as a wireless communication network, it is contemplated that communication network 130 may include wireline networks such as, for example, Ethernet, fiber-optic, waveguide, or any other type of wired communication network.

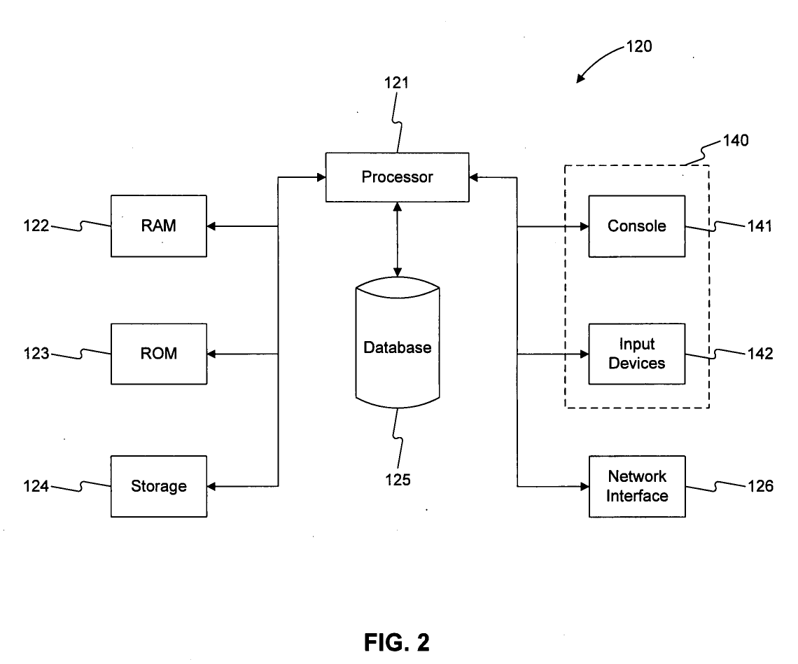

As illustrated in FIG. 2, data collection system 120 may include various components for running software applications. For example, data collection system 120 may include, among other things, a processor 121, a random access memory (RAM) 122, a read-only memory (ROM) 123, a storage 124, a database 125, a network interface 126, and a user interface 140. Data collection system 120 may be a standalone unit or may be integrated within a centralized data system associated with work machine environment 100.

User interface 140 may include devices configured to interact with a user associated with work machine environment 100. For example, user interface 140 may include, among other things, a console 141 and one or more input devices 142. Console 141 may provide a graphical user interface (GUI) to display information to a user of work machine environment 100. Console 141 may include any suitable display device or computer monitor. Input devices 142 may include devices configured to receive information entered by the user such as, for example, a keyboard, disc drive, mouse, voice recognition system, or any other hardware or software device for receiving information from a user associated with work machine environment 100.

Processor 121 may include one or more electronic devices, such as a central processing unit (CPU), that may be configured to execute instructions that perform various processes related to the collection and distribution of operation data associated with work machine environment 100. For example, processor 121 may execute software instructions that transmit, receive, store, analyze, compile, organize, and/or sort information associated with work machine environment 100.

Processor 121 may be configured to receive a set of parameters from controller 103 indicative of the data elements that controller 103 is capable of monitoring. For example, controller 103 may be coupled to electronic control module 101a associated with a motor. Electronic control module 101a may be configured to monitor parameters related to the operation of the motor such as, winding temperature, core temperature, rotor speed, bearing noise, torque output, etc. Processor 121 may receive each of the parameters automatically or in response to a request sent to controller 103.

Processor 121 may also be configured to provide the set of parameters to a user via user interface 140. For example, processor 121 may output the set of parameters on a display associated with console 141 using a graphical user interface. This may provide the user with a mechanism to review the parameters capable of being monitored by controller 103. The user may also be allowed to specify which parameters data collection system 120 collects during subsequent operations of work machine 110 by selecting one or more parameters from among the set of parameters.

Processor 121 may be further configured to collect operation data based on the parameters selected by the user and provide the collected data to the user via user interface 140. For example, based on the user-selected parameters, processor 121 may send a request to controller 103, prompting controller 103 to collect operation data associated with the parameters selected by the user. Processor 121 may then execute software and/or perform processes that receive the requested data, format the data in a suitable (e.g., predefined) output format, and provide the data to the user through user interface 140.

It is contemplated that processor 121 may be configured to perform additional and/or different processes than those listed above to enable data collection system 120 to collect and distribute user-selected information to systems operating in work machine environment 100. For example, processor 121 may execute software that performs analysis of operation data, generates status reports, records historical operation data and/or sets of parameters in memory, provides software updates to controller 103, and/or any other operation associated with the collection and distribution of information in work machine environment 100.

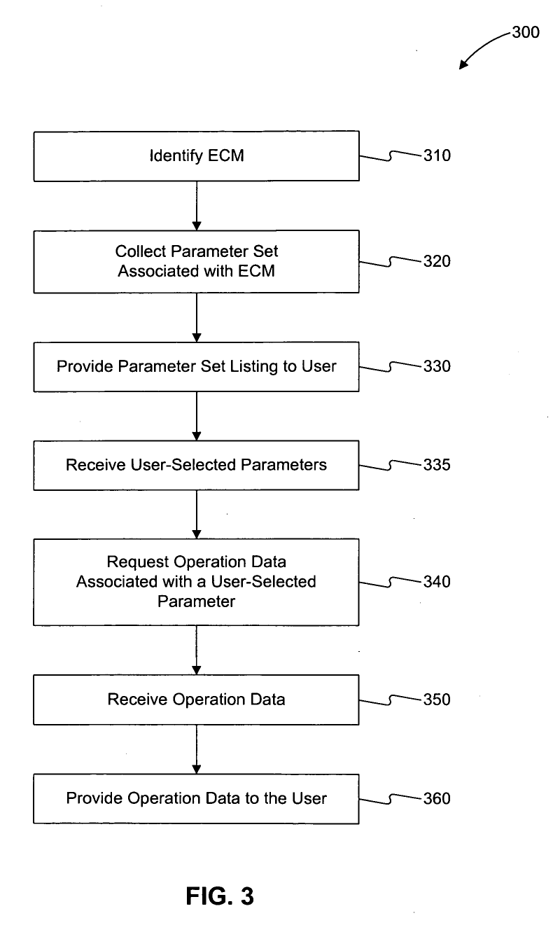

Methods and systems consistent with the disclosed embodiments may provide an environment that enables real-time collection and distribution of information based on user-selected parameters. FIG. 3 illustrates a flowchart 300 depicting an exemplary method for gathering user-selected parameters. As illustrated in FIG. 3, data collection system 120 may identify one or more controllers 103 associated with work machine 110 (Step 310). Data collection system 120 may identify each controller 103 in response to a particular event, such as upon start-up of work machine 110. Alternatively and/or additionally, data collection system 120 may broadcast a request over communication network 130 and receive identification information from one or more controllers 103 in response to the request.

Once controller 103 has been identified, data collection system 120 may collect a set of parameters indicative of the data elements that controller 103 is capable of monitoring (Step 320). These parameters may include one or more components (e.g., electronic control modules 101a-c, monitoring devices (not shown), etc.) or component parameters (e.g., temperature, pressure, etc.) associated with the particular controller 103. For example, controller 103 may include electronic control module 101b associated with a cooling system of work machine 110 that may be configured to monitor, among other things, the temperature, pressure, fluid level, flow rate, and viscosity of a coolant. Data collection system 120 may collect these parameters and store them in database 125 for further analysis.

Data collection system 120 may provide a listing of the set of parameters to a user via user interface 140 (Step 330). The parameter listing may provide the user with a list of each component associated with work machine 110 and all of the corresponding data elements that can be monitored. Following the example above, data collection system 120 may display each of the parameters associated with the cooling system on console 141. Furthermore, data collection system 120 may group each set of parameters with the appropriate electronic control module from which it was collected.

Data collection system 120 may then receive one or more parameters selected by the user from among the set of parameters provided to the user (Step 335). From the example above, the user may wish to monitor only temperature and pressure from among the set of cooling system parameters provided by controller 103. The user may select these parameters using input devices 142 associated with user interface 140. Data collection system 120 may automatically configure itself to collect and report operation data associated with the particular set of user-selected parameters.

Data collection system 120 may request operation data from controller 103 during operations of work machine 10 based on the one or more user-selected parameters (Step 340). For example, data collection system 120 may request the operation data associated with the temperature and pressure of the cooling system. Alternatively and/or additionally, data collection system 120 may request all available operation data from controller 103 and designate only cooling system temperature and pressure as user-selected parameters.

Data collection system 120 may receive the operation data from controller 103 in response to the request (Step 350) and provide the data to the user interface 140 (Step 360). For example, data collection system 120 may receive the requested operation data associated with the user-selected parameters and display the data on console 141 associated with user interface 140. From the example above, data collection system 120 may provide the cooling system temperature and pressure operation data to the user interface 140, as requested by the user.

Although the exemplary method described above has been described as being performed by data collection system 120, it is contemplated that different and/or additional devices may perform the method. Alternatively and/or additionally, the method may be implemented manually, by one or more software programs as part of a computer system, or using any combination of manual, software, and/or hardware configuration suitable to perform the method.

### INDUSTRIAL APPLICABILITY

Although the disclosed embodiments are described in connection with work machine environment 100, the disclosed data collection system 120 may be applicable to any environment where it may be desirable to customize the data collection and/or distribution capabilities in accordance with user-selected requirements. Specifically, the disclosed data collection system may collect and distribute operation data to a user based on parameters selected by the user.

Because data collection system 120 may be configured to collect and distribute information based on user-selected parameters, it may improve personnel and system efficiency. For example, instead of transmitting all available operation data associated with the work machine to the user, which could overload communication network 130, data collection system 120 may transmit only the specific operation data associated with the user-selected parameters. Moreover, because users may receive operation data associated with only those parameters that they select, the potential for wasting time spent sorting through large amounts of raw data may be reduced or eliminated.

In addition, data collection system 120 may provide a flexible, cost effective mechanism for monitoring work machine environment 100. For example, because data collection system 120 is fully customizable based on user inputs, separate data collection systems may not be required for each different entity associated with work machine environment 100. Thus, users with different interests in work machine environment 100 that require different sets of operation data may not be required to develop separate collection and distribution programs that sort through data based on the particular interests of the user. This flexible system may significantly reduce or eliminate costs associated with developing separate monitoring systems for each respective user.

It will be apparent to those skilled in the art that various modifications and variations can be made to the disclosed data collection system without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for gathering user-selected parameters in a work machine environment comprising:
receiving a set of parameters associated with a controller;
providing the received set of parameters to a user interface, wherein the user interface is configured to allow a user to select one or more parameters from among the received set of parameters; and
receiving operation data based on the one or more parameters selected by the user, wherein the operation data reflects an aspect associated with an operation of the work machine.

2. The method of claim 1, wherein receiving the set of parameters includes:
requesting the set of parameters from the controller; and
receiving the set of parameters in response to the request.

3. The method of claim 1, wherein receiving the set of parameters includes:
requesting an identifier from the controller; and
receiving the set of parameters associated with the identifier in response to the request.

4. The method of claim 1, wherein receiving the set of parameters includes automatically receiving the set of parameters from the controller.

5. The method of claim 1, wherein providing the set of parameters to the user interface includes receiving one or more parameters selected by the user from among the received set of parameters.

6. The method of claim 1, wherein receiving operation data includes:
requesting, from the controller, operation data associated with the one or more parameters selected by the user; and
receiving operation data in response to the request.

7. The method of claim 1, wherein receiving operation data includes providing the received operation data to the user via the user interface.

8. The method of claim 7, wherein providing the received operation data includes providing the received operation data automatically as the operation data is being received from the controller.

9. The method of claim 1, wherein the operation data includes data reflecting at least one operational characteristic associated with the one or more parameters selected by the user.

10. The method of claim 1, wherein the set of parameters includes one or more data elements that are capable of being monitored by the control module.

11. The method of claim 10, wherein the one or more data elements include an identification of a component associated with the work machine.

12. The method of claim 10, wherein the one or more data elements include an operational characteristic of a component associated with the work machine.

13. A data collection system for collecting operation data in a work machine environment, comprising:
a user interface configured to communicate information with a user associated with the work machine environment;
a processor communicatively coupled to the user interface and configured to:
receive a set of parameters associated with a controller;
provide the received set of parameters to the user interface; and
receive operation data based on one or more parameters selected by the user, wherein the operation data reflects an aspect associated with an operation of the work machine.

14. The system of claim 13, wherein the user interface is configured to allow a user to select one or more parameters from among the received set of parameters.

15. The system of claim 13, wherein providing the set of parameters to the user interface includes receiving one or more parameters selected by the user from among the received set of parameters.

16. The system of claim 13, wherein receiving the set of parameters includes:
requesting the set of parameters from the controller; and
receiving the set of parameters in response to the request.

17. The system of claim 13, wherein receiving the set of parameters includes:
requesting an identifier from the controller; and
receiving the set of parameters associated with the identifier in response to the request.

18. The system of claim 13, wherein receiving the set of parameters includes automatically receiving the set of parameters from the controller.

19. The system of claim 13, wherein receiving operation data includes:
requesting, from the controller, the operation data associated with the one or more parameters selected by the user; and
receiving the operation data in response to the request.

20. The system of claim 13, wherein the processor is communicatively coupled to the controller via a wireless communication network.

21. The system of claim 13, wherein receiving operation data includes providing the received operation data to the user via the user interface.

22. The system of claim 21, wherein providing the received operation data includes providing the received operation data automatically as the operation data is being received from the controller.

23. The system of claim 13, wherein the operation data includes data reflecting at least one operational characteristic associated with the one or more parameters selected by the user.

24. The system of claim 13, wherein the set of parameters includes one or more data elements that are capable of being monitored by the control module.

25. The system of claim 24, wherein the one or more data elements include an identification of a component associated with the work machine.

26. The system of claim 24, wherein the one or more data elements include an operational characteristic of a component associated with the work machine.

27. A work machine environment, comprising:
a work machine configured to perform a task associated with the work machine environment, the work machine including a controller operatively coupled to a component of the work machine and configured to collect operation data associated with one or more parameters associated with the work machine or the component of the work machine;
a data collection system communicatively coupled to the work machine and including:
a user interface configured to communicate information with a user associated with the work machine environment;
a processor communicatively coupled to the user interface and configured to:
receive a set of parameters associated with the controller of the work machine;
provide the received set of parameters to the user interface; and
receive at least a portion of the operation data based on one or more parameters selected by the user, wherein the operation data reflects an aspect associated with an operation of the work machine.

28. The environment of claim 27, wherein the user interface is configured to allow a user to select one or more parameters from among the received set of parameters.

29. The environment of claim 27, wherein providing the set of parameters to the user interface includes receiving one or more parameters selected by the user from among the received set of parameters.

30. The environment of claim 27, wherein receiving the set of parameters includes:
requesting the set of parameters from the controller; and
receiving the set of parameters in response to the request.

31. The environment of claim 27, wherein receiving the set of parameters includes:
requesting an identifier from the controller; and
receiving the set of parameters associated with the identifier in response to the request.

32. The environment of claim 27, wherein receiving the set of parameters includes automatically receiving the set of parameters from the controller.

33. The environment of claim 27, wherein receiving at least a portion of the operation data operation data includes:
requesting, from the controller, the portion of the operation data associated with the one or more parameters selected by the user; and
receiving the portion of the operation data in response to the request.

34. The environment of claim 27, wherein the processor is communicatively coupled to the controller via a wireless communication network.

35. The environment of claim 27, wherein receiving the portion of the operation data includes providing the received portion of the operation data to the user via the user interface.

36. The environment of claim 35, wherein providing the received portion of the operation data includes providing the received portion of the operation data automatically as the operation data is being received from the controller.

37. The environment of claim 27, wherein the set of parameters includes one or more data elements that are capable of being monitored by the control module.

38. The environment of claim 37, wherein the one or more parameters include an identification of a component associated with the work machine.

39. The environment of claim 37, wherein the one or more parameters include an operational characteristic of a component associated with the work machine.
